(19) United States
(12) Patent Application Publication
(10) Pub. No.: US 2026/0142375 A1
(43) Pub. Date: May 21, 2026

(54) DEVICE INCLUDING A FLEXIBLE ANTENNA

(71) Applicant: Senseonics, Incorporated, Germantown, MD (US)

(72) Inventors: Vasily Dronov, Germantown, MD (US); James Masciotti, Germantown, MD (US); Pavel Beresnev, Germantown, MD (US); Lee Johnson, Germantown, MD (US)

(73) Assignee: Senseonics, Incorporated, Germantown, MD (US)

(21) Appl. No.: 19/373,885

(22) Filed: Oct. 30, 2025

Related U.S. Application Data
(60) Provisional application No. 63/721,186, filed on Nov. 15, 2024.

(51) Int. Cl. H01Q 7/08; H01Q 1/22

(52) U.S. Cl. CPC H01Q 7/08; H01Q 1/2291

(57) ABSTRACT

A device including a core and a printed circuit board (PCB) including a circuit portion and an antenna portion. The circuit portion may include one or more circuit components. The one or more circuit components may include measurement electronics and a measurement controller. The antenna portion may include a flexible substrate and an antenna. The antenna portion may be configured to wrap around the core. The device may include a housing. The PCB and the core may be located within the housing. The antenna portion of the PCB may be configured to unroll such that, after the PCB is inserted within the housing, at least a portion of the antenna portion is in contact with an internal surface of the housing.

### CROSS-REFERENCE TO RELATED APPLICATION

The present application claims the benefit of priority to U.S. Provisional Application No. 63/721,186, filed Nov. 15, 2024, which is incorporated herein by reference in its entirety.

### BACKGROUND

### Field of Invention

The present invention relates generally to a device including printed circuit board (PCB) having a flexible antenna portion. More specifically, the present invention relates to a device including a core and a flexible antenna portion wrapped around the core, which may enable the device to communicate with an external device at multiple angles while the device is implanted in a body environment.

### Discussion of the Background

Implantable devices implanted in the body of a living animal may use an antenna to communicate with external devices (e.g., to receive information such as commands and/or calibration information and to convey information such as measurements and/or status information). A user of an external device may initiate communication with the implanted device by positioning the external device in proximity to the implanted device at a particular angle relative to the antenna of the implanted device. However, an implanted device may shift unexpectedly after implantation, which may result in the position of the antenna being unknown to the user. Without knowing the position of the antenna, it may be difficult to consistently convey and receive the signals between the implantable device and external devices.

### SUMMARY

Aspects of the present invention may relate to an improved device (e.g., an improved implantable device) including an antenna that is capable of communicating with an external device at multiple different angles (e.g., while the device is implanted in a body environment).

One aspect of the present invention may provide a device including a core and a printed circuit board (PCB). The PCB may include a circuit portion and an antenna portion. The circuit portion may include one or more circuit components. The antenna portion may include a flexible substrate and an antenna. The antenna portion may wrap around the core.

In some aspects, the device may include a housing, and the PCB and the core may be located within the housing. In some aspects, the device may include an encasement material configured to encase the PCB and the core within the housing. In some aspects, the encasement material may include epoxy. In some aspects, the core may have a magnetic permeability greater than a magnetic permeability of free space. In some aspects, the housing may include an internal surface, and at least a portion of the antenna portion of the PCB may be in contact with the internal surface of the housing.

In some aspects, the circuit portion of the PCB may have a first side and a second side. In some aspects, a length of the first side may be greater than a length of the second side. In some aspects, the antenna portion may extend from the first side of the circuit portion.

In some aspects, the circuit portion of the PCB may have a first side and a second side. In some aspects, a length of the first side may be greater than a length of the second side. In some aspects, the antenna portion may extend from the second side of the circuit portion.

In some aspects, the one or more circuit components may include measurement electronics and a measurement controller. In some aspects, the measurement controller may be configured to cause the measurement electronics to perform a measurement sequence. In some aspects, the circuit portion of the PCB may include a flexible substrate and a stiffener. In some aspects, the circuit portion of the PCB may include a rigid substrate. In some aspects, the circuit portion of the PCB may include a capacitor. In some aspects, the circuit portion of the PCB may include one or more solder pads. In some aspects, the antenna may be a flat loop antenna.

In some aspects, the core may include a top surface and a curved bottom surface. In some aspects, the circuit portion of the PCB may be disposed on the top surface of the core. In some aspects, the antenna portion of the PCB may wrap around the curved bottom surface of the core.

In some aspects, the antenna may be configured to transmit data to a near field communication (NFC) antenna of a device. In some aspects, the antenna may be configured to detect a magnetic field from the NFC antenna at any angle of the antenna relative to the NFC antenna. In some aspects, the antenna may be configured to be in a same plane as the NFC antenna. In some aspects, the antenna may be disposed on a side of the device facing the device.

In some aspects, the core may include ferrite, NiZn, and/or MnZn.

Another aspect of the present invention may provide a method including wrapping an antenna portion of a printed circuit board (PCB) around a core. The PCB may include a circuit portion and the antenna portion. The circuit portion may include one or more circuit components. The antenna portion may include a flexible substrate and an antenna.

In some aspects, the method may include inserting the PCB and the core within a housing. In some aspects, the method may include using an encasement material to encase the PCB and the core within the housing. In some aspects, the encasement material may include epoxy. In some aspects, the housing may include an internal surface, and, after the PCB is inserted within the housing, the antenna portion of the PCB may unroll until at least a portion of the antenna portion of the PCB is in contact with the internal surface of the housing.

In some aspects, the circuit portion of the PCB may have a first side and a second side. In some aspects, a length of the first side may be greater than a length of the second side. In some aspects, the antenna portion may extend from the first side of the circuit portion.

In some aspects, the circuit portion of the PCB may have a first side and a second side. In some aspects, a length of the first side may be greater than a length of the second side. In some aspects, the antenna portion may extend from the second side of the circuit portion.

In some aspects, the one or more circuit components may include measurement electronics and a measurement controller. In some aspects, the measurement controller may be configured to cause the measurement electronics to perform a measurement sequence. In some aspects, the circuit portion of the PCB may include a flexible substrate and a stiffener. In some aspects, the circuit portion of the PCB may include a rigid substrate. In some aspects, the circuit portion of the PCB may include a capacitor. In some aspects, the circuit portion of the PCB may include one or more solder pads. In some aspects, the antenna may be a flat loop antenna.

In some aspects, the core may include a top surface and a curved bottom surface. In some aspects, the circuit portion of the PCB may be disposed on the top surface of the core. In some aspects, wrapping the antenna portion of the PCB around the core may include wrapping the antenna portion around the curved bottom surface of the core.

Further variations encompassed within the systems and methods are described in the detailed description of the invention below.

### BRIEF DESCRIPTION OF THE DRAWINGS

The accompanying drawings, which are incorporated herein and form part of the specification, illustrate various, non-limiting embodiments of the present invention. In the drawings, like reference numbers indicate identical or functionally similar elements.

FIG. 1 is a block diagram illustrating an exemplary system according to some aspects.

FIGS. 2A and 2B are cross-sectional views of an implantable device of the system according to some aspects.

FIG. 3 is a top view of components of an implantable device of the system according to some aspects.

FIGS. 4A and 4B are side views of components of an implantable device of the system according to some aspects.

FIG. 5 is a block diagram of an analyte sensor of the system according to some aspects.

FIG. 6 is a schematic view illustrating an exemplary computer of the system according to some aspects.

FIG. 7 is a flowchart illustrating a process according to some aspects.

### DETAILED DESCRIPTION OF PREFERRED EMBODIMENTS

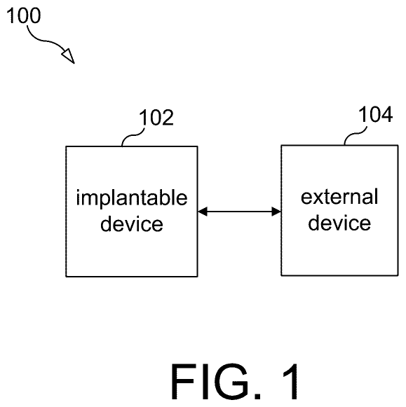

FIG. 1 is a schematic view of a system 100 embodying aspects of the present invention. In some aspects, as shown in FIG. 1, the system 100 may include an implantable device 102 and an external device 104. In some aspects, the implantable device 102 may be fully implantable (e.g., subcutaneously) within the body of a user (e.g., a human user). In some alternative aspects, the implantable device 102 may be partially implantable (e.g., transcutaneously) within the body of a user. In some aspects, the system 100 may be an analyte monitoring system, and the implantable device 102 may be an analyte sensor. However, this is not required, and, in some alternative aspects, the system 100 may be a different type of system (e.g., the system 100 may be a pacemaking system, and the implantable device 102 may be a pacemaker). In some aspects, the external device 104 may be external to the body of the user. In some aspects, the external device 104 may be, for example and without limitation, a smartphone or other device capable of being carried by the user, a transceiver or other device capable of being worn by the user (e.g., attached via an armband, wristband, waistband, or adhesive patch), or a personal computer (e.g., a laptop or desktop computer). In some aspects, the implantable device 102 may be capable of communication with the external device 104 while the implantable device 102 is implanted within the body of the user.

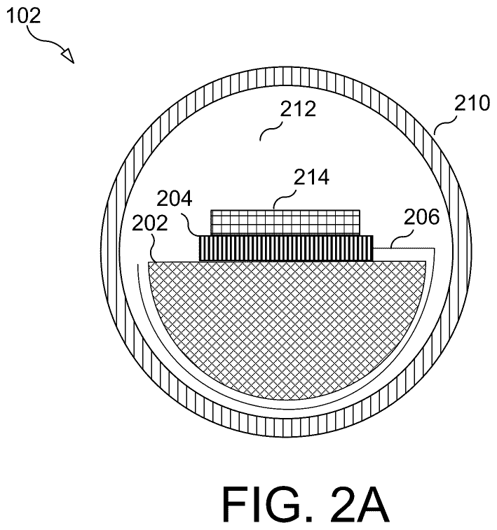

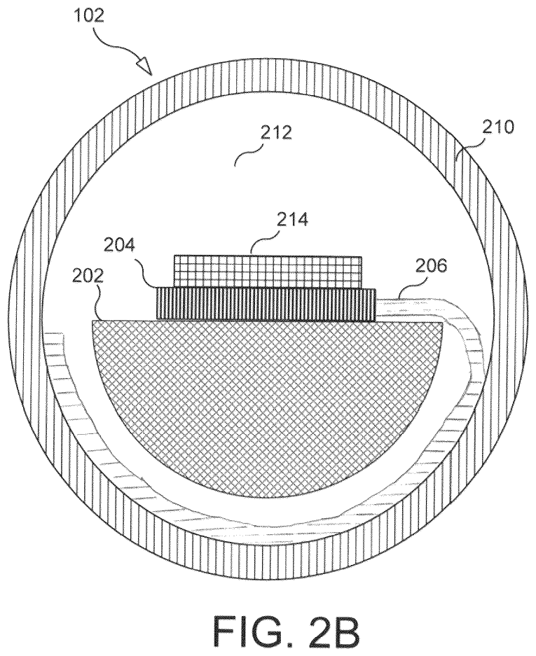

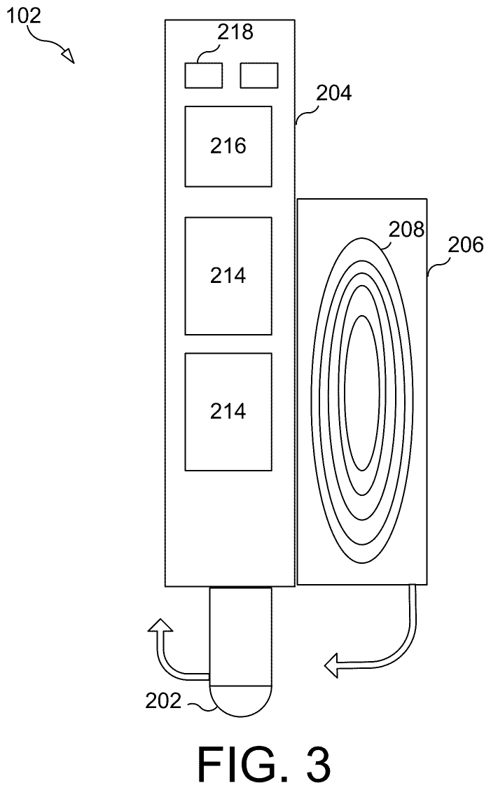

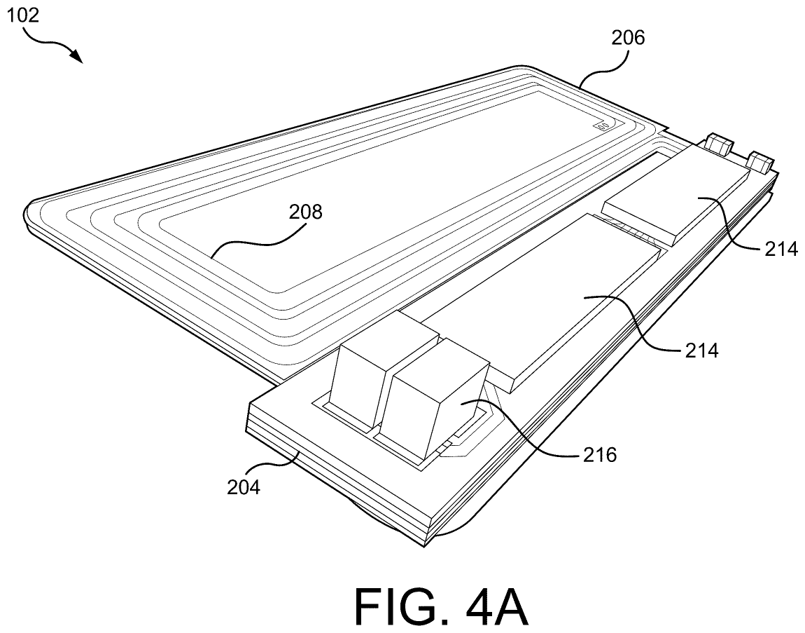

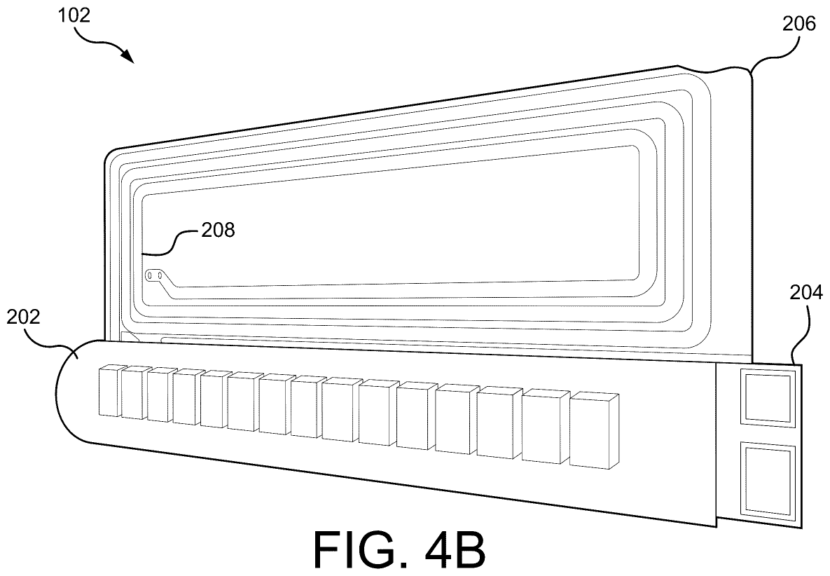

FIGS. 2A and 2B illustrate a cross-sectional view of the implantable device 102 according to some aspects in which the implantable device 102 includes a printed circuit board (PCB) 204 that includes a flexible antenna portion. FIG. 3 illustrates a top view of components of the implantable device 102 according to some aspects in which the implantable device 102 includes a PCB that includes a flexible antenna portion. FIGS. 4A and 4B illustrate alterative side views of the implantable device 102 according to some aspects in which the implantable device 102 includes a PCB that includes a flexible antenna portion.

In some aspects, as shown in FIGS. 2A-4B, the implantable device 102 may include a core 202 and a PCB 204. In some aspects, the PCB 204 may include a circuit portion and an antenna portion 206. In some aspects, the core 202 may include a top surface and a bottom surface. In some aspects, as shown in FIGS. 2A and 2B, the top surface of the core 202 may be a flat surface, and the bottom surface of the core 202 may be a curved surface. In some aspects, the circuit portion of the PCB 204 may be disposed on the top surface of the core 202. In some aspects, the antenna portion 206 of the PCB 204 may wrap around the bottom surface of the core 202. In some aspects, the antenna portion 206 wrapped around the bottom surface of the core 202 may be configured to face the external device 104. That is, in some aspects, when implanted, the device 102 may be configured to be positioned such that the antenna portion 206, which is wrapped around the bottom surface of the core 202, faces an expected position of the external device 104. For example, in some aspects in which the external device 104 is configured to be attached (e.g., adhered) to or placed in proximity to the skin of the user, the implantable device 102 may be configured to be positioned such that the antenna portion 206 faces the skin surface under which the device 102 is implanted. In some aspects, the core 202 may have a magnetic permeability greater than the magnetic permeability of free space. That is, in some aspects, the core 202 may have a relative magnetic permeability (μᵣ) greater than 1. In some aspects, the core 202 may include ferrite, NiZn, and/or MnZn. However, this is not required, and, in some alternative aspects, different materials and/or shapes may be used for the core 202.

In some aspects, as shown in FIGS. 3-4B, the circuit portion of the PCB 204 may have a first side and a second side, a length of the first side may be greater than a length of the second side. In some aspects, the antenna portion 206 may extend from the first side of the circuit portion. However, this is not required, and, in some alternative aspects, the antenna portion 206 may extend from the second side of the circuit portion. In some aspects, the circuit portion of the PCB 204 may include a flexible substrate and a stiffener. In some aspects, the stiffener may be under one or more circuit components 214 (e.g., one or more integrated circuits (ICs)) of the PCB 204. In some alternative aspects, the circuit portion of the PCB 204 may include a rigid substrate. However, this is not required, and, in other aspects, different materials and/or shapes may be used for the PCB 204 and antenna portion 206.

In some aspects, as shown in FIGS. 3-4B, the antenna portion 206 may include a flexible substrate and an antenna 208. In some aspects, the antenna 208 may be a flat loop antenna. In some aspects, the flat loop antenna may be cylindrically formed to maximize a cross section. However, this is not required, and, in other aspects, different shapes may be used for the antenna 208. In some aspects, the antenna 208 may be configured to transmit data to a near field communication (NFC) antenna of external device 104. In some aspects, the antenna 208 may be configured to detect a magnetic field from the NFC antenna at any angle of the antenna relative to the NFC antenna of the external device 104. In some aspects, the antenna 208 may be configured to be in a same plane as the NFC antenna. In some aspects, the antenna 208 may be positioned at a first side of the implantable device 102, and the first side of the implantable device 102 may face the external device 104.

In some aspects, the configuration of the core 202 and/or the antenna 208 may impact the ability of the implantable device 102 to communicate with the external device 104. In some aspects (e.g., some aspects in which the antenna 208 has a six turn in-plane flexible antenna configuration), the antenna 208 may have an approximate area of 16 mm×37 mm in which an iPhone 13 is capable of reading ASIC IDs of the implantable device 102 from a distance of 6 mm from a surface of the housing 210 (e.g., 7.5 mm from a surface of the core 202).

In some aspects, as shown in FIGS. 2A-3, the circuit portion of the PCB 204 may include one or more circuit components 214. In some aspects, the one or more circuit components 214 may be one or more integrated circuits (ICs). In some aspects, one or more of the one or more circuit components 214 may be an application-specific integrated circuit (ASIC). In some aspects, the circuit components 214 may include measurement electronics and a measurement controller. In some aspects, the measurement controller may be configured to cause the measurement electronics to perform a measurement sequence. In some aspects, the circuit portion of the PCB 204 may include a capacitor 216 and one or more solder pads 218. In some aspects, an energy storage device (e.g., a battery, supercapacitor, or fuel cell) may be electrically connected to the solder pads 218.

In some aspects, as shown in FIGS. 2A and 2B, the implantable device 102 may include a device housing 210 (i.e., body, shell, capsule, tube, or encasement). In some aspects, the device housing 210 may include an internal surface. In some aspects, as shown in FIG. 2B, at least a portion of the antenna portion 206 of the PCB 204 may be in contact with the internal surface of the device housing 210. In some aspects, the device housing 210 may be rigid and/or biocompatible. In some aspects, the device housing 210 may be a silicon tube. In some aspects, the device housing 210 may have a cylindrical shape. However, this is not required, and, in some alternative aspects, different materials and/or shapes may be used for the device housing 210. In some aspects, as shown in FIGS. 2A and 2B, the implantable device 102 may include a cavity 212 (e.g., within the housing 210). In some aspects, the cavity 212 may include an encasement material. In some aspects, the encasement material may be an epoxy. However, this is not required, and, in other aspects, different materials may be used for the encasement material of the cavity 212.

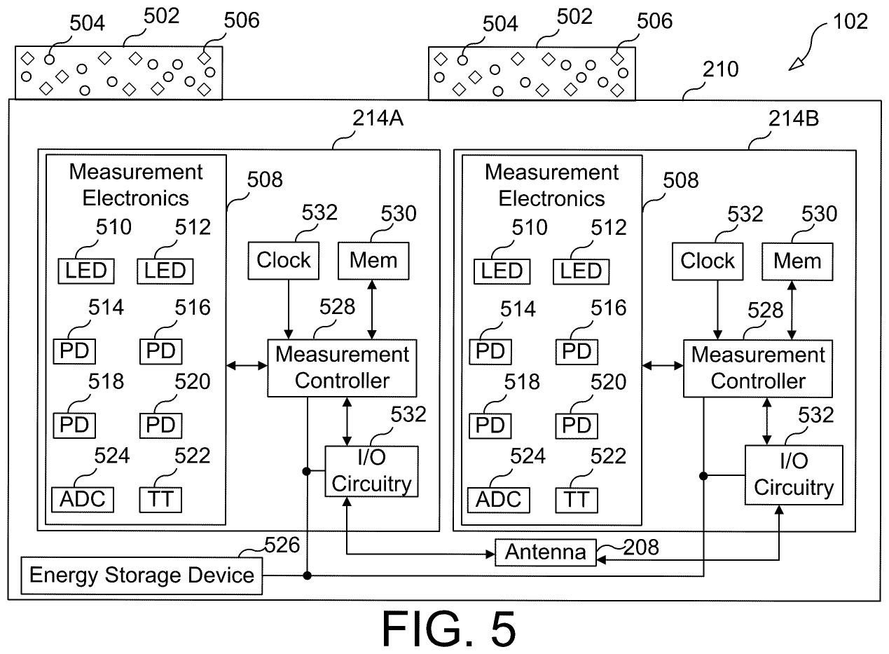

FIG. 5 is a block diagram illustrating the implantable device 102 according to some aspects in which the system 100 is an analyte monitoring system and the implantable device 102 is an analyte sensor. In some aspects, as shown in FIG. 5, the implantable device 102 may include analyte and/or interferent indicator material 502, which may be, for example, polymer grafts or hydrogels coated, diffused, adhered, embedded, or grown on or in one or more portions of an exterior surface of the housing 210. In some aspects, the analyte and/or interferent indicator material 502, may be porous and may allow the analyte (e.g., glucose) in a medium (e.g., interstitial fluid) to diffuse into the analyte and/or interferent indicator material 502.

In some aspects, as shown in FIG. 5, the analyte and/or interferent indicator material 502 may include analyte indicator molecules 504 and/or interferent indicator molecules 506 (e.g., degradation indicator molecules). In some aspects, the implantable device 102 may use the analyte indicator molecules 504 to measure the presence, amount, and/or concentration of an analyte (e.g., glucose, oxygen, cardiac markers, low-density lipoprotein (LDL), high-density lipoprotein (HDL), or triglycerides). In some aspects, the circuit components 214 may use the interferent indicator molecules 506 to measure in vivo (e.g., ROS induced) signal degradation. In some aspects, in the analyte and/or interferent indicator material 502, the analyte indicator molecules 504 and/or the interferent indicator molecules 506 may be copolymerized into a single biocompatible hydrogel. In some aspects, the analyte indicator molecules 504 and/or the interferent indicator molecules 506 may have negligible spectral overlap and undergo similar degradation (e.g., similar degradation of boronic acids) in vivo.

In some aspects, the analyte indicator molecules 504 may have one or more detectable properties (e.g., optical properties) that vary in accordance with (i) the amount or concentration of the analyte in proximity to the analyte and/or interferent indicator material 502 and (ii) an effect on the analyte indicator molecules 504 (e.g., changes to the analyte indicator molecules 504). In some aspects, the changes to the analyte indicator molecules 504 may include the extent to which the analyte indicator molecules 504 have degraded. In some aspects, the degradation may be (at least in part) ROS-induced oxidation. In some aspects, the analyte indicator molecules 504 may be fluorescent analyte indicator molecules. In some aspects, the analyte indicator molecules 504 may be distributed throughout the analyte and/or interferent indicator material 502. In some aspects, the analyte indicator molecules 504 may be phenylboronic-based analyte indicator molecules. However, a phenylboronic-based analyte indicator is not required, and, in some alternative aspects, the implantable device 102 may include different analyte indicator molecules, such as, for example and without limitation, glucose oxidase-based indicators, glucose dehydrogenase-based indicators, and glucose binding protein-based indicators.

In some aspects, the interferent indicator molecules 506 may have one or more detectable properties (e.g., optical properties) that vary in accordance with changes to the interferent indicator molecules 506. In some aspects, the interferent indicator molecules 506 are not sensitive to the amount of concentration of the analyte in proximity to the analyte and/or interferent indicator material 502. That is, in some aspects, the one or more detectable properties of the interferent indicator molecules 506 do not vary in accordance with the amount or concentration of the analyte in proximity to the analyte and/or interferent indicator material 502. However, this is not required, and, in some alternative aspects, the one or more detectable properties of interferent indicator molecules 506 may vary in accordance with the amount or concentration of the analyte in proximity to the analyte and/or interferent indicator material 502.

In some aspects, the changes to the interferent indicator molecules 506 may include the extent to which the interferent indicator molecules 506 have degraded. In some aspects, the degradation may be (at least in part) ROS-induced oxidation. In some aspects, the interferent indicator molecules 506 may be fluorescent interferent indicator molecules. In some aspects, the interferent indicator molecules 506 may be distributed throughout the analyte and/or interferent indicator material 502. In some aspects, the interferent indicator molecules 506 may be phenylboronic-based interferent indicator molecules. However, phenylboronic-based interferent indicator molecules are not required, and, in some alternative aspects, the circuit components 214 may include different interferent indicator molecules 506, such as, for example and without limitation, amplex red-based interferent indicator molecules, dichlorodihydrofluorescein-based interferent indicator molecules, dihydrorhodamine-based interferent indicator molecules, and scopoletin-based interferent indicator molecules.

In some aspects, the system 100 may use the interferent indicator molecules 506 of the analyte and/or interferent indicator material 502, which may by sensitive to degradation by reactive oxygen species (ROS) but not sensitive to the analyte, to measure indirectly changes to the analyte indicator molecules 504 of an analyte and/or interferent indicator material 502. In some aspects, the interferent indicator molecules 506 may have one or more optical properties that change with extent of oxidation and may be used as a reference for measuring and correcting for extent of oxidation of the analyte indicator molecules 504. In some aspects, the extent to which the interferent indicator molecules 506 have degraded may correspond to the extent to which the analyte indicator molecules 504 have degraded. For example, in aspects, the extent to which the interferent indicator molecules 506 have degraded may be proportional to the extent to which the analyte indicator molecules 504 have degraded. In some aspects, the extent to which the analyte indicator molecules 504 have degraded may be calculated based on the extent to which the interferent indicator molecules 506 have degraded. In some aspects, the system 100 may correct for changes in the analyte indicator molecules 504 using an empiric correlation established through laboratory testing.

In some aspects, as shown in FIG. 5, the circuit components 214 may include measurement electronics 508 (e.g., optical measurement electronics). In some aspects, the measurement electronics 508 may include one or more light sources and/or one or more photodetectors. For example, in some aspects, as shown in FIG. 5, the measurement electronics 508 may include one or more first light sources 510 that emit first excitation light over a wavelength range that interacts with the analyte indicator molecules 504 in the analyte and/or interferent indicator material 502. In some aspects, the first excitation light may be ultraviolet (UV) light. In some aspects, the circuit components 214 may include one or more second light sources 512 that emit second excitation light over a wavelength range that interacts with the interferent indicator molecules 506 in the analyte and/or interferent indicator material 502. In some aspects, the second excitation light may be, for example and without limitation, blue light.

In some aspects, the analyte indicator molecules 504 may emit first emission light (e.g., fluorescent light) when irradiated by the first excitation light. In some aspects, an analyte (e.g., glucose) may bind reversibly to some of the analyte indicator molecules 504, and the amount of first emission light emitted by an analyte indicator molecule 504 may vary based on whether the analyte is bound to the analyte indicator molecule 504. For example, when irradiated by the first excitation light, an analyte indicator molecule 504 may emit a relatively large amount of first emission light if the analyte is bound to analyte indicator molecule 504 and may emit a relatively small amount of first emission light if analyte is not bound to the analyte indicator molecule 504. Therefore, the amount of first emission light emitted by the analyte indicator molecules 504 may vary based on the concentration of the analyte in proximity to the analyte and/or interferent indicator material 502. In some aspects, the amount of first emission light emitted by the analyte indicator molecule 504 may also vary based on an amount of interference (e.g., the extent to which the analyte indicator molecules 504 have degraded).

In some aspects, the interferent indicator molecules 506 may emit second emission light (e.g., fluorescent light) when irradiated by the second excitation light. In some aspects, the amount of second emission light emitted by the interferent indicator molecules 506 may vary based on an amount of interference (e.g., the extent to which the interferent indicator molecules 506 have degraded). In some aspects, the amount of second emission light emitted by the interferent indicator molecules 506 does not vary based on the concentration of the analyte in proximity to the analyte and/or interferent indicator material 502. In some aspects, degradation (e.g., oxidation) of the interferent indicator molecules 506 may additionally or alternatively cause the absorption of the interferent indicator molecules 506 (e.g., absorption of the second excitation light by the interferent indicator molecules 506) to change.

In some aspects, as shown in FIG. 5, the measurement electronics 508 of the circuit components 214 may also include one or more photodetectors 514, 516, 518 (e.g., photodiodes, phototransistors, photoresistors, or other photosensitive elements). In some aspects, the measurement electronics 508 of the circuit components 214 may include one or more signal photodetectors 514 sensitive to first emission light (e.g., fluorescent light) emitted by the analyte indicator molecules 504 such that a signal generated by a signal photodetector 514 is indicative of the level of first emission light of the analyte indicator molecules 504 and, thus, the amount of analyte of interest (e.g., glucose). In some aspects, the measurement electronics 508 may include one or more reference photodetectors 516 sensitive to first excitation light that may be reflected from the analyte and/or interferent indicator material 502 such that a signal generated by a photodetector 516 in response thereto is indicative of the level of reflected first excitation light. In some aspects, the circuit components 214 may include one or more interferent photodetectors 518 sensitive to second emission light (e.g., fluorescent light) emitted by the interferent indicator molecules 506 such that a signal generated by an interferent photodetector 518 in response thereto that is indicative of the level of second emission light of the interferent indicator molecules 506 and, thus, the amount of degradation (e.g., oxidation). In some aspects, the one or more signal photodetectors 514 may be sensitive to second excitation light that may be reflected from the analyte and/or interferent indicator material 502. In this way, the one or more signal photodetectors 514 may act as reference photodetectors when the one or more second light sources 512 are emitting second excitation light.

However, it is not required that the one or more signal photodetectors 514 act as reference photodetectors when the one or more second light sources 512 are emitting second excitation light. In some alternative aspects, as shown in FIG. 5, the measurement electronics 508 of the circuit components 214 may include one or more second reference photodetectors 520 that act as reference photodetectors when the one or more second light sources 512 are emitting second excitation light. In some aspects, the one or more second reference photodetectors 520 may be sensitive to second excitation light that may be reflected from the analyte and/or interferent indicator material 502 such that a signal generated by a photodetector 520 in response thereto is indicative of the level of reflected second excitation light.

In some aspects, one or more of the photodetectors 514, 516, 518, 520 may be covered by one or more filters that allow only a certain subset of wavelengths of light to pass through and reflect (or absorb) the remaining wavelengths. In some aspects, one or more filters on the one or more signal photodetectors 514 may allow only a subset of wavelengths corresponding to first emission light and/or the reflected second excitation light. In some aspects, one or more filters on the one or more reference photodetectors 516 may allow only a subset of wavelengths corresponding to the reflected first excitation light. In some aspects, one or more filters on the one or more interferent photodetectors 518 may allow only a subset of wavelengths corresponding to second emission light. In some aspects in which the circuit components 214 include one or more second reference photodetectors 520, one or more filters on the one or more second reference photodetectors 520 may allow only a subset of wavelengths corresponding to the reflected second excitation light.

In some aspects, as shown in FIG. 5, the measurement electronics 508 of the circuit components 214 may include one or more temperature transducers 522. In some aspects, the measurement electronics 508 may include one or more light source drivers, one or more amplifiers, one or more analog-to-digital convertors (ADCs) 524, one or more comparators, and/or one or more multiplexors. In some aspects, the one or more ADCs 524 may convert analog signals output by the photodetectors 514, 516, 518, 520 and/or one or more temperature transducers 522 to digital signals.

In some aspects, as shown in FIG. 5, the implantable device 102 may include an energy storage device 526 (e.g., a battery, a supercapacitor, or a fuel cell) and the antenna 208, and the circuit components 214 may include a measurement controller 528, a memory 530, a clock 532, and/or input/output (I/O) circuitry 532. In some aspects, the circuit components 214 may be powered at least partially by the energy storage device 526. In some aspects, as shown in the FIG. 5, the energy storage device 526 may be in the housing 210 of the implantable device 102. However, this is not required, and, in some alternative aspects, the energy storage device 526 may be external to the housing 210. In some alternative aspects in which the energy storage device 526 is external to the housing 210, the energy storage device 526 may be attached to the housing 210 (e.g., via a coupler).

In some aspects, the I/O circuitry 532 may include I/O digital circuitry and/or I/O analog circuitry. In some aspects, the antenna 208 may be electrically connected to the I/O circuitry 532, which may use current flowing through the antenna 208 to generate power for the circuit components 214 and/or to extract data from the current. In some aspects, the I/O circuitry 532 may also convey data (e.g., to a transceiver and/or a display device) by modulating the current flowing through the antenna 208. In some aspects, the I/O circuitry 532 may (at least at times) be electrically connected to and powered by the energy storage device 526.

In some aspects, when electrically connected to and powered by the energy storage device 526, the clock 532 may provide a continuous clock for driving circuitry of the circuit components 214 (e.g., even when the circuit components 214 is not receiving power from an external device). In some aspects, the measurement controller 528 may be a computer. In some aspects, the circuit components 214 may use the continuous clock output of the clock 532 to keep track of time and initiate autonomous, self-powered analyte measurements when appropriate (e.g., at periodic intervals, such as, for example, every minute, every two minutes, every 5 minutes, every 10 minutes, every 15 minutes, every half-hour, every hour, every two hours, every six hours, every twelve hours, or every day). In some aspects, the measurement controller 528 may control the measurement electronics 508 to perform an autonomous analyte measurement sequence, and the results of the autonomous analyte measurement may be stored in the memory 530. The autonomous analyte measurements may be stored in the memory 530. In some aspects, the I/O circuitry 532 may convey one or more of the stored measurements to the external device at a later time. For example, in some request aspects, the I/O circuitry 532 may convey one or more of the stored measurements in response to the circuit components 214 receiving and decoding a measurement data request from a transceiver.

In some aspects, the memory 530 may be a nonvolatile storage medium. In some aspects, the memory 530 may be an electrically erasable programmable read only memory (EEPROM). However, in some alternative aspects, other types of nonvolatile storage media, such as flash memory, may be used. In some aspects, the memory 530 may include an address decoder. In some aspects, the memory 530 may store measurement information autonomously generated while the circuit components 214 is powered from the energy storage device 526. In some aspects, the memory 530 may additionally or alternatively store one or more time-stamps identifying when the measurement data was generated, sensor calibration data, a unique sensor identification, setup information, and/or integrated circuit calibration data. In some aspects, the unique identification information may, for example, enable full traceability of the circuit components 214 through its production and subsequent use.

In some aspects, the circuit components 214 may include one sensing device, which may include the measurement electronics 508 that interact with (e.g., emits excitation light to and detects light reflected and/or emitted by) the analyte and/or interferent indicator material 502, a measurement controller 528, and I/O circuitry 532. However, this is not required, and, in some alternative aspects, the circuit components 214 may include a different number of sensing devices (e.g., two, three, four, five, ten, etc.). For example, as shown in FIG. 5, the circuit components 214 may include first and second sensing devices 214A and 214B. In some aspects, the sensing devices 214A and 214B may each include measurement electronics 508 that interact with analyte and/or interferent indicator material 502 on a portion of the exterior surface of the housing 210, a measurement controller 528, and I/O circuitry 532. In some aspects, the sensing devices 214A and 214B may share an energy storage device 526 and/or an antenna 208. That is, in some aspects in which the circuit components 214 includes multiple sensing devices, the antenna 208 may be electrically connected to the circuitry of the multiple sensing devices (e.g., sensing devices 214A and 214B), and the energy storage device 526 may be connected to the circuitry of the multiple sensing devices.

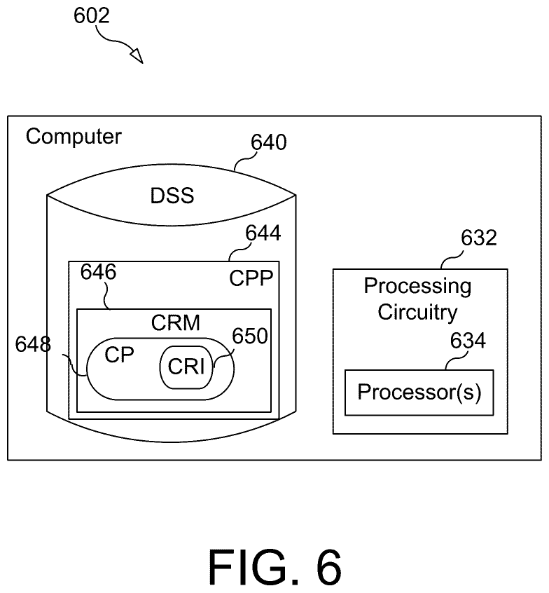

FIG. 6 is a block diagram of an aspect of a computer 602 (e.g., a computer of the implantable device 102 and/or a computer of the external device 104) of the system 100. For example, in some aspects, the implantable device 102 (e.g., the one or more circuit components 214 of the implantable device 102) may include a computer 602. As shown in FIG. 6, in some aspects, the computer 602 may include processing circuitry 632 and/or one or more circuits, such as an application specific integrated circuit (ASIC), field-programmable gate arrays (FPGAs), a logic circuit, and the like. The processing circuitry 632 may include one or more processors 634 (e.g., one or more general purpose microprocessors). In some aspects, the computer 602 may include a data storage system (DSS) 640. The DSS 640 may include one or more non-volatile storage devices and/or one or more volatile storage devices (e.g., random access memory (RAM)). In aspects where the computer 602 includes processing circuitry 632, the DSS 640 may include a computer program product (CPP) 644. CPP 644 may include or be a computer readable medium (CRM) 646. The CRM 646 may store a computer program (CP) 648 including computer readable instructions (CRI) 650. The CRM 646 may be a non-transitory computer readable medium, such as, but not limited, to magnetic media (e.g., a hard disk), optical media (e.g., a DVD), solid state devices (e.g., random access memory (RAM) or flash memory), and the like. In some aspects, the CRI 650 of computer program 648 may be configured such that when executed by processing circuitry 632, the CRI 650 causes the computer to perform steps described below (e.g., steps described above with reference to the process 700). In other aspects, the computer may be configured to perform steps described herein without the need for a computer program. That is, for example, the computer may consist merely of one or more ASICs. Hence, the features of the aspects described herein may be implemented in hardware and/or software.

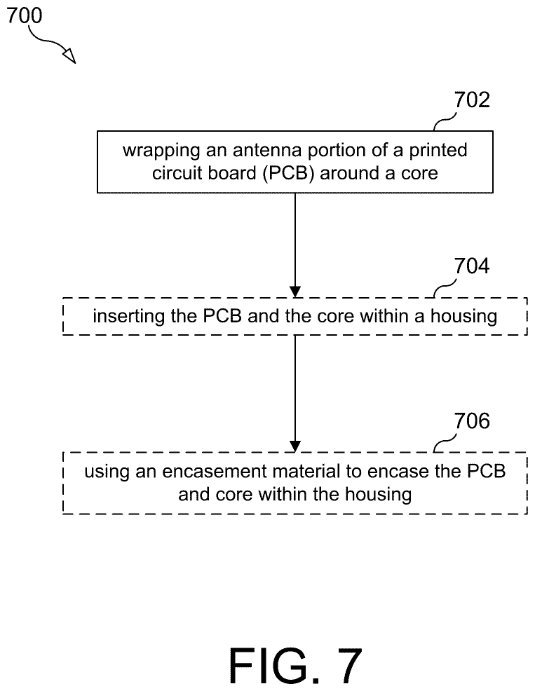

FIG. 7 illustrates a manufacturing process 700 according to some aspects. In some aspects, as shown in FIG. 7, the process 700 may include a step 702 of wrapping an antenna portion 206 of a PCB 204 around a core 202. In some aspects, the core 202 may include a top surface and a bottom surface. In some aspects, the top surface of the core 202 may be flat, and the bottom surface of the core 202 may be curved. In some aspects, the circuit portion of the PCB 204 may be disposed on the top surface of the core 202. In some aspects, wrapping the antenna portion 206 of the PCB 240 around the core 202 may include wrapping the antenna portion 206 around the bottom surface of the core 202. In some aspects, the antenna portion 206 wrapped around the bottom surface of the core 202 may be configured to face the external device 104. In some aspects, the core 202 may have a magnetic permeability greater than the magnetic permeability of free space. That is, in some aspects, the core 202 may have a relative magnetic permeability (μᵣ) greater than 1. In some aspects, the core 202 may include ferrite, NiZn, and/or MnZn. However, this is not required, and, in other aspects, different materials and/or shapes may be used for the core 202.

In some aspects, the circuit portion of the PCB 204 may have a first side and a second side, a length of the first side may be greater than a length of the second side. In some aspects, the antenna portion 206 may extend from the first side of the circuit portion. In some alternative aspects, the antenna portion 206 may extend from the second side of the circuit portion. In some aspects, the circuit portion of the PCB 204 may include a flexible substrate and a stiffener. In some aspects, the stiffener may be under one of one or more the circuit components 214 (e.g., one or more ICs) of the PCB 204. In some aspects, the circuit portion of the PCB may include a rigid substrate. However, this is not required, and, in other aspects, different materials and/or shapes may be used for the PCB 204 and antenna portion 206.

In some aspects, the antenna portion 206 may include a flexible substrate and an antenna 208. In some aspects, the antenna 208 may be a flat loop antenna. In some aspects, the flat loop antenna may be cylindrically formed to maximize a cross section. However, this is not required, and, in other aspects, different shapes may be used for the antenna 208. In some aspects, the antenna 208 may be configured to transmit data to a near field communication (NFC) antenna of external device 104. In some aspects, the antenna 208 may be configured to detect a magnetic field from the NFC antenna at any angle of the antenna relative to the NFC antenna of the external device 104. In some aspects, the antenna 208 may be configured to be in a same plane as the NFC antenna. In some aspects, the antenna 208 may be positioned at a first side of the implantable device 102 and the first side of the implantable device 102 may face the external device 104.

In some aspects, the circuit portion of the PCB 204 may include one or more circuit components 214. In some aspects, the one or more circuit components 214 may be one or more ICs. In some aspects, one or more of the one or more circuit components 214 may be an ASIC. In some aspects, the one or more circuit components 214 may include measurement electronics and a measurement controller. In some aspects, the measurement controller may be configured to cause the measurement electronics to perform a measurement sequence. In some aspects, the circuit portion of the PCB 204 may include a capacitor 216 and one or more solder pads 218. In some aspects, an energy storage device (e.g., a battery, supercapacitor, or fuel cell) may be electrically connected to the solder pads 218.

In some aspects, as shown in FIG. 7, the process 700 may include an optional step 704 of inserting the PCB 204 and the core 202 within a housing 210. In some aspects, the device housing 210 may be rigid and/or biocompatible. In some aspects, the device housing 210 may be a silicon tube. In some aspects, the device housing 210 may have a cylindrical shape. However, this is not required, and, in other aspects, different materials and/or shapes may be used for the device housing 210. In some aspects, the device housing 210 may include an internal surface. In some aspects, as shown in FIG. 2B, after the PCB 204 is inserted within the device housing 210, the antenna portion 206 of the PCB 204 may unroll until at least a portion of the antenna portion 206 of the PCB 204 is in contact with the internal surface of the device housing 210.

In some aspects, as shown in FIG. 7, the process 700 may include an optional step 706 of using an encasement material to encase the PCB 204 and core 202 within the housing 210. In some aspects, implantable device 102 may include a cavity 212 (e.g., within the housing 210). In some aspects, the cavity 212 may include an encasement material. In some aspects, the encasement material may be an epoxy. However, this is not required, and, in other aspects, different materials may be used for the encasement material of the cavity 212.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

What is claimed is:

1. A device comprising:
a core; and
a printed circuit board (PCB) including a circuit portion and an antenna portion, wherein the circuit portion comprises one or more circuit components, the antenna portion comprises a flexible substrate and an antenna, and the antenna portion wraps around the core.

2. The device of claim 1, further comprising a housing, wherein the PCB and the core are located within the housing.

3. The device of claim 2, further comprising an encasement material configured to encase the PCB and the core within the housing.

4. The device of claim 3, wherein the encasement material comprises epoxy.

5. The device of claim 2, wherein the housing includes an internal surface, and at least a portion of the antenna portion of the PCB is in contact with the internal surface of the housing.

6. The device of claim 1, wherein the circuit portion of the PCB has a first side and a second side, a length of the first side is greater than a length of the second side, and the antenna portion extends from the first side of the circuit portion.

7. The device of claim 1, wherein the circuit portion of the PCB has a first side and a second side, a length of the first side is greater than a length of the second side, and the antenna portion extends from the second side of the circuit portion.

8. The device of claim 1, wherein the one or more circuit components comprise measurement electronics and a measurement controller, and the measurement controller is configured to cause the measurement electronics to perform a measurement sequence.

9. The device of claim 1, wherein the circuit portion of the PCB comprises a flexible substrate and a stiffener.

10. The device of claim 1, wherein the circuit portion of the PCB comprises a rigid substrate.

11. The device of claim 1, wherein the circuit portion of the PCB comprises:
a capacitor; and
one or more solder pads.

12. The device of claim 1, wherein the antenna is a flat loop antenna.

13. The device of claim 1, wherein the core comprises a top surface and a curved bottom surface, the circuit portion of the PCB is disposed on the top surface of the core, and the antenna portion of the PCB is wraps around the curved bottom surface of the core.

14. The device of claim 1, wherein the antenna is configured to transmit data to a near field communication (NFC) antenna of a device.

15. The device of claim 14, wherein the antenna is configured to detect a magnetic field from the NFC antenna at any angle of the antenna relative to the NFC antenna.

16. The device of claim 14, wherein the antenna is configured to be in a same plane as the NFC antenna.

17. The device of claim 14, wherein the antenna is disposed on a side of the device facing the device.

18. The device of claim 1, wherein the core has a magnetic permeability greater than a magnetic permeability of free space.

19. The device of claim 1, wherein the core comprises ferrite, NiZn, and/or MnZn.

20. A method comprising:
wrapping an antenna portion of a printed circuit board (PCB) around a core, wherein the PCB includes a circuit portion and the antenna portion, the circuit portion comprises one or more circuit components, and the antenna portion comprises a flexible substrate and an antenna.

21. The method of claim 20, further comprising inserting the PCB and the core within a housing.

22. The method of claim 21, further comprising using an encasement material to encase the PCB and the core within the housing.

23. The method of claim 22, wherein the encasement material comprises epoxy.

24. The method of claim 21, wherein the housing comprises an internal surface, and, after the PCB is inserted within the housing, the antenna portion of the PCB unrolls until at least a portion of the antenna portion of the PCB is in contact with the internal surface of the housing.

25. The method of claim 20, wherein the circuit portion of the PCB has a first side and a second side, a length of the first side is greater than a length of the second side, and the antenna portion extends from the first side of the circuit portion.

26. The method of claim 20, wherein the circuit portion of the PCB has a first side and a second side, a length of the first side is greater than a length of the second side, and the antenna portion extends from the second side of the circuit portion.

27. The method of claim 20, wherein the one or more circuit components comprises measurement electronics and a measurement controller, and the measurement controller is configured to cause the measurement electronics to perform a measurement sequence.

28. The method of claim 20, wherein the circuit portion of the PCB comprises a flexible substrate and a stiffener.

29. The method of claim 20, wherein the circuit portion of the PCB comprises a rigid substrate.

30. The method of claim 20, wherein the circuit portion of the PCB comprises a capacitor and one or more solder pads.

31. The method of claim 20, wherein the antenna is a flat loop antenna.

32. The method of claim 20, wherein the core comprises a top surface and a curved bottom surface, the circuit portion of the PCB is disposed on the top surface of the core, and wrapping the antenna portion of the PCB around the core comprises wrapping the antenna portion around the curved bottom surface of the core.
